(19) United States
(12) Patent Application Publication
(10) Pub. No.: US 2006/0177113 A1
(43) Pub. Date: Aug. 10, 2006

(54) Method and apparatus for determining a stable repeatable code from biometric information

(75) Inventor: Peter Wrage, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Liska Biometry Inc., Dover, NH (US)

(21) Appl. No.: 11/050,726

(22) Filed: Feb. 7, 2005

(51) Int. Cl. G06K 9/00

(52) U.S. Cl. 382/124; 382/115

(57) ABSTRACT

Disclosed is a method of deriving a biometric identification number and an extended biometric identification number. The biometric identification number is derived based on a plurality of different fingerprint images of a same finger time. The resulting biometric identification number represents those features within the finger tip that are determined to be most stable. Values are determined based on each feature in accordance with characteristics that are determinable in a stable fashion. The resulting biometric identification number is representative of the fingerprint. In order to extend the biometric identification number, further personal data relating to a same individual as the finger tip is encoded within the extended biometric identification number.

### FIELD OF THE INVENTION

The present invention relates to fingerprint authentication and, more specifically, to a method and system for mapping a fingerprint image into a numerical code such that the code resulting from fingerprint images taken from a same donor finger under varying environmental conditions exhibits sufficient similarity to confirm authentication.

### BACKGROUND OF THE DISCLOSURE

In order for fingerprint recognition to gain widespread acceptance as a reliable live-scan authentication tool, high authentication accuracy based on fingerprint images is required. Much of the work in this area has focused on feature by feature comparison of fingerprint images.

A common method of feature by feature comparison involved forming a registration fingerprint template during user registration. The registration template includes a plurality of features and information relating to each feature. During authentication, a fingerprint image is acquired and it is analyzed to extract features for comparison against the template. For each feature a comparison is performed resulting in an overall likelihood of accuracy in user identification. The likelihood of accuracy is then compared against a threshold likelihood to determine if security of the system is maintainable by identifying the individual. If it is, the person is identified. Otherwise, they are rejected.

Unfortunately, templates formed for feature by feature comparison are unordered and are not rapidly comparable one to another. As such, it would be beneficial to hash a fingerprint for rapid classification and rapid comparison. Unfortunately, due to the variance in image capture such as variable conditions and variable image capture angle, two fingerprints are rarely if ever identical even when taken from a same fingertip. Changes in finger tip pressure, angle, moisture, and so forth change the resulting fingerprint. Therefore, hashing a fingerprint results in a hash code that is not particularly useful for user identification.

Two factors that limit the capability of live-scan devices to achieve high authentication accuracy are the rate of false acceptance and the rate of false rejection. The false acceptance rate is the frequency with which a device would wrongly accept the fingerprint of a donor during a matching operation between a query print from the donor and a different donor's pre-stored template. The false rejection rate is the frequency with which a device would wrongly reject the fingerprint of a donor during a matching operation between a query print from the donor and the donor's own pre-stored template. Solving the problem of achieving a high authentication accuracy therefore reduces to keeping the rates of false acceptance and false rejection to within acceptable upper bounds.

A general approach to reducing the false acceptance rate is to seek out features that are unique amongst fingerprint images from different donors. Much research has been done in this area over the last century, with computerized matching techniques having been introduced more recently. However, despite enormous investments by governments and corporations, fingerprint authentication has still not become the choice identification technology for most high-reliability applications. A reason for this is that many of the authentication methods that are capable of lowering the false acceptance rate actually suffer from a high false rejection rate. In other words, existing fingerprint authentication methods are often incapable of recognizing that certain features, which appear to be different between a query image and a pre-stored template, may in fact originate from the same fingerprint.

A general approach to reducing the false rejection rate is to seek out features of a fingerprint image that do not vary when images are taken from the same donor finger. However, this requirement is difficult to satisfy, as a given donor's finger will likely have a different orientation, humidity, temperature and/or pressure at the time when a query print is taken, compared to the time at which the pre-stored template was taken. Moreover, there is an added difficulty of ensuring that improvements in terms of lowering the false rejection rate do not cause the false acceptance rate to increase beyond an acceptable level.

It would be advantageous to provide a method of determining a stable re-determinable numeric result by processing a fingerprint such that the numerical result is comparable with a numerical result derived from processing a different fingerprint of a same finger tip of a same individual.

### SUMMARY OF THE INVENTION

In accordance with the invention there is provided a method of generating a biometric identification number comprising: receiving a plurality of fingerprint images, each fingerprint image different one from another and each fingerprint image of a same finger tip; using graph theory and based on the plurality of fingerprint images, determining a plurality of stable features within the plurality of fingerprint images; determining, for each of the plurality of stable features, at least a value based on at least a characteristic thereof; and encoding of the at least a value for each of the plurality of stable features within a code relating to the same finger tip, the code for supporting uniqueness and searchability thereof within a database of codes.

According to another aspect of the invention there is provided a biometric identification number comprising: a code comprising at least an encoded value for each of a plurality of stable features, the code relating to a same finger tip, the code for supporting uniqueness and searchability thereof within a database of codes, the plurality of stable features derived from each of a plurality of fingerprint images, each fingerprint image different one from another and each fingerprint image of the same finger tip; the at least an encoded value based on at least a characteristic of a feature.

### BRIEF DESCRIPTION OF THE DRAWINGS

FIG. 1 is a simplified flow diagram of a method of selecting stable features from within a plurality of fingerprints of a same fingertip;

FIG. 2 is a simplified flow diagram of a method of encoding data based on the stable features determined in accordance with the method of FIG. 1;

FIG. 3 is a simplified flow diagram of a method of using a biometric identification number to access records within a database wherein a field within each record of the database and having a biometric identification number stored therein forms an index thereof;

FIG. 4 is a simplified flow diagram of a method of generating an extended biometric identification number;

FIG. 5 is a simplified flow diagram of an alternative method of generating an extended biometric identification number; and,

FIG. 6 is a diagram of a barcode encoding an extended biometric identification number.

### DETAILED DESCRIPTION OF AN EMBODIMENT OF THE INVENTION

In U.S. Pat. No. 6,757,411 entitled “Method and system for fingerprint encoding and authentication,” herein incorporated by reference, a method of determining a barcode from a live fingerprint is disclosed. For use in user authentication, such a method is advantageous due to its speed of comparison. Unfortunately, the repeatability and reliability of the numbers generated to form the barcodes is extremely important to any such system functioning adequately.

The reference relies upon minutia-based techniques for fingerprint matching. Minutia-based techniques first find minutiae points and then map their relative placement on the finger. Therefore, this version of the biometric identification number is sensitive to the accuracy of the determined positions of each minutia within a given fingerprint. Of course, reducing the precision of the determinations results in more repeatability at the expense of quantisation error.

According to the reference, a fingerprint image is processed to result in a code. The code is stored within a database and is later usable for one-to-one matching of an individual. Because of the nature of the code, it can be rotationally and translationally invariant and has other benefits such as compactness and reliability. That said, any code for use in one-to-one mapping is similar to a template in function, if not in form. The code described above is verifiable according to a measure of similarity of any symbols—bytes—within the code. Though the code is beneficial for many applications, it is not intended for use as an exact match verification process. Further, inconsistencies between a template code and a code derived from a live fingerprint may occur throughout the code, as such rendering it unacceptable for use in indexing of data.

According to the present invention a fixed-length, near-constant number is extractable from a fingerprint pattern. This short numeric code of about 50 bytes serves as the unique biometric identification number of the person providing the fingerprint image.

This initial code in the form of a biometric identification number is generated from fingerprint data, for example, a fingerprint template. It is used to authenticate and verify an individual's fingerprint and because the code is very short, it is storable on a card having very limited storage, such as magnetic stripe card.

For any minutia based identification technique, there are many characteristics of each minutia that are identifiable. For example, each minutia typically has a type, for example bifurcation or endpoint; a direction, for example ridge direction; and a location, for example a distance and angle relative to the core. Of course other minutia characteristics are also known and are useful with the present invention.

According to the present invention, a code is extracted from a fingerprint to result in an index or a portion of an index. As such, the code is preferably relatively stable such that an index based search of a database is performable therewith.

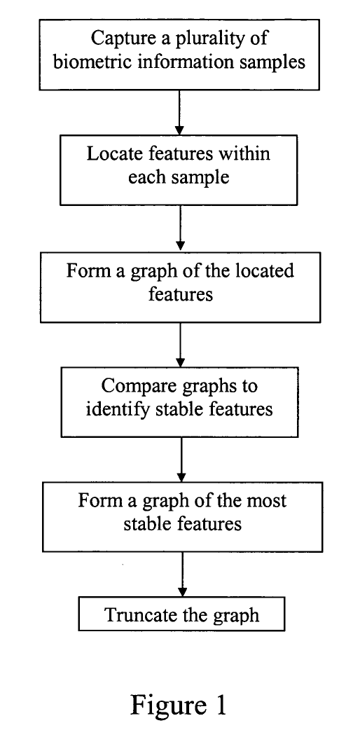

Referring to FIG. 1, a method of determining a stable set of features from a fingerprint template is shown. The fingerprint is imaged numerous times, preferably under different conditions such as time of day, moisture level, and imaging device configurations. From each of the plurality of acquired fingerprints, a set of features is extracted and a graph is formed. These graphs are then compared to graphs from each other acquired fingerprint template to determine a subset of graph elements that are the most stable. Graph theory is used in order to correlate features in the form of minutia and in order to determine a stable set of features and connectivity therefor. Transformation, rotation and distortion-correction techniques are used to determine a most stable set of features for the fingerprints provided. The graph is then truncated. By truncating the graph to a subset of most stable features, the false rejection rate is maintained within acceptable limits. By selecting sufficient stable features, the false acceptance rate is maintained within acceptable limits.

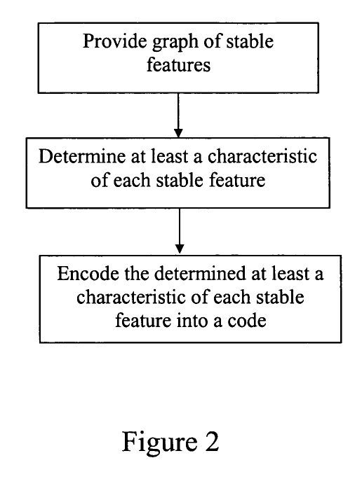

Referring to FIG. 2, the selected features within the truncated graph are then encoded into a number in order to provide a stable numerical code. For the code to be considered stable, it is desirable that the resulting code be defined within predetermined limits of codes generated during subsequent fingerprint analysis. For example, encoding is performed in dependence upon a plurality of considerations. More stable features are encoded in higher order locations within the code. Quantisation error resulting from code generation is most acceptable when repeatable. Less repeatable values are encoded at lower order locations with the code. The final stable set of features is then stored by type and location.

For example, when 5 stable features are determined and each has five bytes of determined characteristics, it is often the case that some of the bits within the determined characteristics are less stable than others. Similarly, it is often the case that different characteristics within the stable characteristics are less stable. For one-to-one authentication according to prior implementations, this is not of significant concern since it is accounted for during authentication.

Accordingly, in order to enhance stability of the code generation from iteration to iteration, analysis of features, feature stability, feature characteristic stability, etc. is used to order the code such that the code is useful as an index to a database of records. In order to account for variability in the lower order bits of the code, a larger search space is typically employed allowing for records having indices within a target range of indices to be retrieved.

The method as shown in FIG. 1 accounts for missing minutia, a common problem, by acquiring numerous fingerprints of a same finger tip in order to form a single biometric identification number. By selecting a small set of features that are highly stable, a compact biometric identification number results that is stable for being repeatably matched with a template of an image of a same live fingertip.

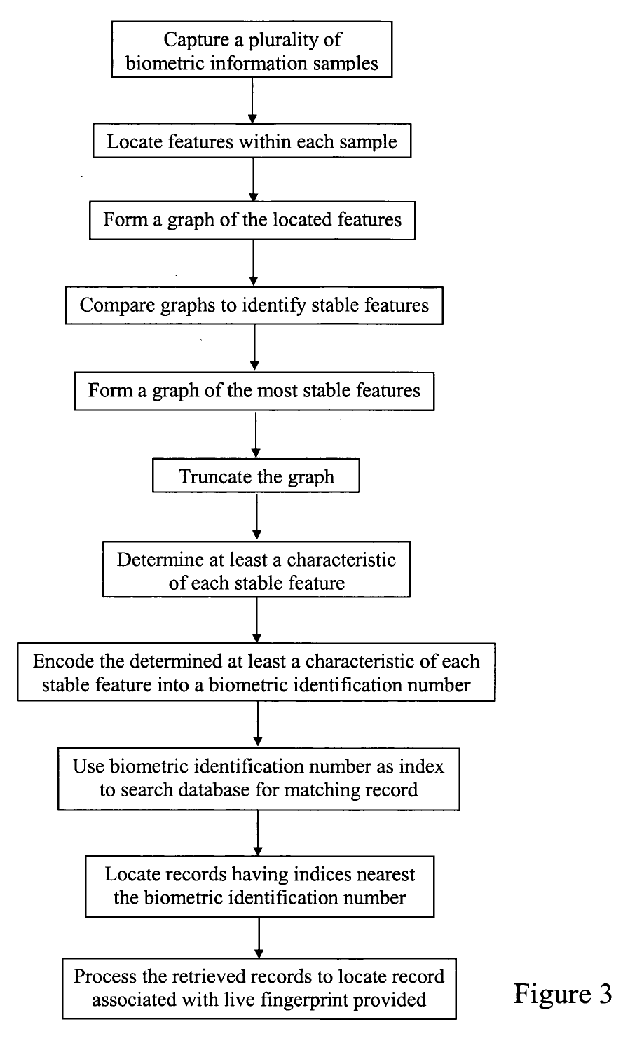

Referring to FIG. 3 during the matching process, a plurality of live fingerprints are captured, each of a same fingertip. A similar process as that used to determine the code is applied for code generation. The resulting code is efficiently seachable within a database given that a field of the code is indexed. The searchability and uniqueness of the code are each defined by different quality measures. For example, according to the present invention, searchability is defined as a probability that a record containing a template corresponding to the live finger tip is included within search results for a code extracted therefrom. Thus, if every generated code is identical, then the searchability is guaranteed. It is considered important that the searchability be reliable. Preferably the searchability is guaranteed. Uniqueness is defined as a measure of a number of expected records retrieved in response to a code extracted from a fingerprint. When a code includes more data relating to a fingerprint, it is typically more unique. More unique codes typically include significant image capture information, which is not repeatably determinable, and as such are not useful as indices. Thus, for the example where all codes are identical, the uniqueness is very low. A more unique code ensures that most of the time a single record is retrieved for a given search.

Historically, a more unique code was only achievable by reducing the repeatability of a one-to-many search. Further, historically, uniqueness and searchability were a trade-off. Thus, in order to accommodate this trade-off, historically a one-to-one search was employed such that searchability was guaranteed and uniqueness was supported.

By encoding the feature data according to the present invention in a fashion supporting searchability while maintaining the feature data, a high level of uniqueness is maintained. As such, by searching one or more ranges of values based on a determined code, it is typical to retrieve a small subset of records and to have within that subset the record relating to the live fingerprint under analysis. This is highly advantageous.

This code can be used for identification based on a sequential 1:1 matching process if the database size (N) is small. The worst case requires N times the matching process through the complete database, therefore the worst case is not scalable for large searches.

The biometric identification number can be embedded in travel documents, such as visas and passports, credit cards, driver's licenses and a host of other personal credentials for personal identification of the individual against either a live fingerprint image or by searching a database containing biometric identifier numbers. This innovative technology will also allow for seamless, integrated identification searches across disparate databases at all levels of government and law enforcement.

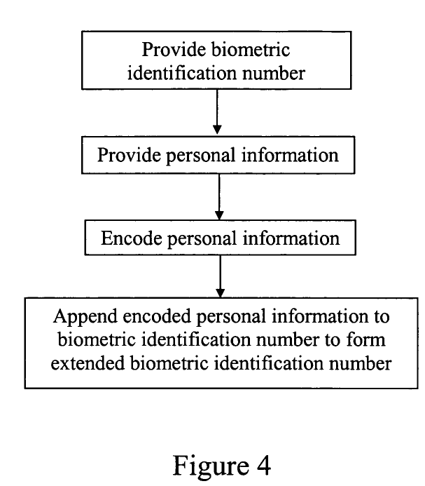

In order to enhance uniqueness and searchability, the biometric identification number is embedded within a code including other data encoded therein. Referring to FIG. 4 for example, personal data of a memorable nature is encoded within an extended portion of the code resulting in an extended biometric identification number to enhance the code's usefulness in indexing large databases.

For example, a person's birth date is encoded as the first three bytes of an extended biometric identifier number. Since a birth date is not a unique identifier, this only reduces the overall search space. That said, for a database including hundreds of millions of records, this simple technique for reducing the search space in a repeatable and reliable fashion is advantageous. Further data such as the person's name, parents' names etc. are also encodable. The resulting extended biometric identification number is very stable in its higher order data providing for enhanced uniqueness and for enhanced searchability.

Quantisation of feature characteristic data encoded within the biometric identification number is now supported without compromising as much on uniqueness. Thus, when a database includes 365 million records of different individuals, and wherein a birth date is encoded absent a year of birth, this results in approximately one million individuals associated with each data. When a name is also encoded, this significantly reduces the number of records associated with the extended portion of the biometric identifier number. Unfortunately, for some names such as “John Smith,” the reduced number of records remains quite large. As such, the biometric identification number (the non-extended portion of the extended biometric identification number) is used to further reduce the resulting set. Given a database of an approximately known size with identifiable searchable individuals therein, a suitable non-extended and extended biometric identification number are designed to support uniqueness and searchability. Preferably a set of records resulting from a search based on an extended biometric identification number is very small and reliably includes the record associated with the fingerprint from which the biometric identification number is determined.

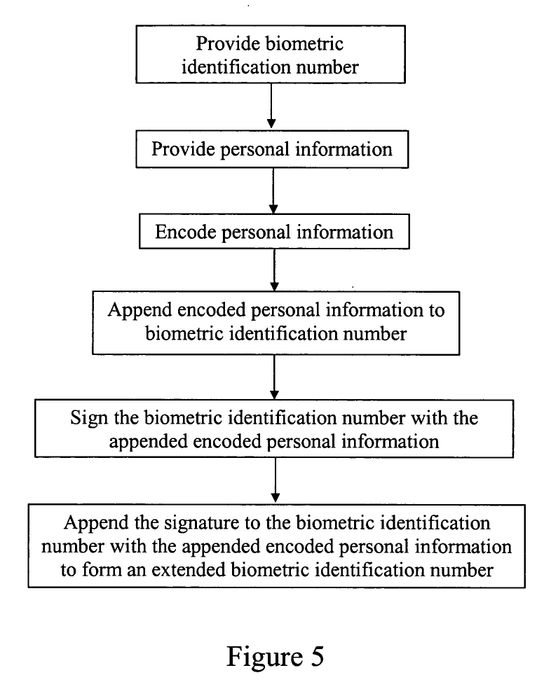

In accordance with an embodiment of the invention, the extended biometric identification number has data encoded therein for ensuring uniqueness thereof and for use in verifying of the security of the extended biometric identifier number. Referring to FIG. 5, personal data of a memorable nature is encoded and appended to the code. The code with the encoded personal data appended thereto is signed. For example, a digital time stamp is applied thereto. The signature is appended to the code with the encoded personal data appended thereto resulting in an extended biometric identification number to enhance the code's usefulness in indexing large databases.

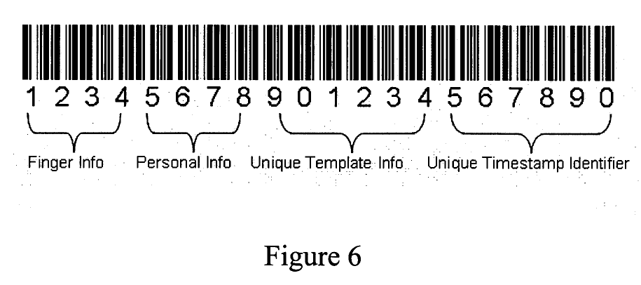

Referring to FIG. 6, a sample extended biometric identification number, encoded as a barcode, is shown. The code comprises 20 bytes and is arranged as follows: finger information is encoded within 4 bytes wherein a first byte is used for the classification of a hand and has values of 1 for the left hand and 2 for the right hand and 0 for an unknown hand. The second byte is for encoding finger information with potential values including {1: Thumb, 2: the second finger, 3: the third finger, 4: the fourth finger, 5: the fifth finger, 0: unknown finger}. Of course, the resulting selection of hands and fingers allows for 33 possibilities and is easily encodable within a single byte should there be a need to encode other information within the barcode. Within the third byte is encoded data for classification of a fingerprint. Potential values include {1: Arch, 2: Tented arch, 3: left loop, 4: right loop, 5: whorl, 6: others; 0: unknown}. The fourth byte is reserved for further data.

Personal Information is encoded within 4 bytes. The first byte is for classification based on gender. Potential values include {1: female, 2: male, 0: unknown}. The remaining three bytes are reserved and may encode data such as birthdate, nationality, name, description, and aliases.

Unique Template Information is encoded within 6 bytes. This information is generated from unique characteristics of the fingerprint template file. The unique template information is usable for verification of the finger template as a digital signature.

Unique Timestamp Identifier is encoded as 6 bytes. This value is generated from a timestamp of the enrollment process. It is used for guaranteeing a unique characteristic of the biometric identification number when used as an index. It is also useful in determining when a card has expired.

Using an extended biometric identification number allows for encoding of other information within the machine readable data on the card such that even when database access is not available, personal information and personal permissions such as license restrictions, visa information, etc. are accessible. Further, the extended biometric identification number is useful for indexing of the database in order to further ensure uniqueness of each index.

Numerous other embodiments may be envisaged without departing from the spirit or scope of the invention.

What is claimed is:

1. A method of generating a biometric identification number comprising:
receiving a plurality of fingerprint images, each fingerprint image different one from another and each fingerprint image of a same finger tip;
using graph theory and based on the plurality of fingerprint images, determining a plurality of stable features within the plurality of fingerprint images;
determining, for each of the plurality of stable features, a value based on at least a characteristic thereof; and
encoding of the value for each of the plurality of stable features within a code relating to the same finger tip, the code for supporting uniqueness and searchability thereof within a database of codes, the code forming at least a portion of the biometric identification number.

2. A method according to claim 1, wherein the code includes values relating to more stable characteristics of more stable features encoded at higher order locations thereof.

3. A method according to claim 2, wherein the code includes less stable characteristics of less stable features encoded in the lower order bits thereof.

4. A method according to claim 1, wherein portions of each value that are less stable are encoded in lower order bits than portion of values that are more stable.

5. A method according to claim 1, wherein at least some of the values are encoded within non-contiguous portions of the code.

6. A method according to claim 1, wherein determining a plurality of stable features includes locating a same feature within each fingerprint image and comparing the located same feature to determine stability thereof in each fingerprint image.

7. A method according to claim 6, wherein stability is determined as a measure of accuracy of extracting at least a value from the located same feature within each fingerprint image, the extracted at least a value being substantially similar to other extracted at least a values for a same feature within each fingerprint image.

8. A method according to claim 6, wherein stability is determined as a measure of accuracy of extracting at least a value from the located same feature within each fingerprint image, the extracted at least a value being identical to other extracted at least a values for a same feature within each fingerprint image.

9. A method according to claim 6, comprising:
analyzing each fingerprint image to determine images that are unsuitable for processing thereof and discarding those images that are unsuitable, the step of determining a plurality of stable features performed only based on those images that are other than discarded.

10. A method according to claim 1, wherein the biometric identification number has appended thereto a code for forming an extended biometric identification number.

11. A method according to claim 10, wherein the extended biometric identification number comprises personal data encoded therein, the personal data known to the individual.

12. A method according to claim 11, wherein the personal data comprises at least one of a name of the individual, a birth date of the individual, a birth place of the individual and a name of a parent of the individual.

13. A method according to claim 10, wherein the extended biometric identification number comprises biometric indicator data indicating a source of the biometric information provided from the individual.

14. A method according to claim 10, wherein the extended biometric identification number includes a signature for verifying an authenticity of at least a portion of the extended biometric identification number.

15. A method according to claim 14, wherein the signature includes time data for forming a time stamp.

16. A method according to claim 1, wherein the biometric identification number comprises fewer than 100 bytes.

17. A biometric identification number comprising:
a code comprising at least an encoded value for each of a plurality of stable features, the code relating to a same finger tip, the code for supporting uniqueness and searchability thereof within a database of codes, the plurality of stable features derived from each of a plurality of fingerprint images, each fingerprint image different one from another and each fingerprint image of the same finger tip; the at least an encoded value based on at least a characteristic of a feature.

18. A biometric identification number according to claim 17, wherein the plurality of stable features are determined using graph theory.

19. A biometric identification number according to claim 18, wherein the encoded values are encoded based on graph theory in a fashion that is translationally and rotationally invariant.

20. A method according to claim 17, wherein the code includes values relating to more stable characteristics of more stable features encoded at higher order locations thereof.

21. A method according to claim 20, wherein the code includes less stable characteristics of less stable features encoded in the lower order bits thereof.

22. A method according to claim 17, wherein portions of each value that are less stable are encoded in lower order bits than portion of values that are more stable.

23. A method according to claim 17, wherein at least some of the values are encoded within non-contiguous portions of the code.

24. A method according to claim 17, wherein the biometric identification number has appended thereto a code for forming an extended biometric identifier number.

25. A method according to claim 24, wherein the extended biometric identification number comprises personal data encoded therein, the personal data known to the individual.

26. A method according to claim 25, wherein the personal data comprises at least one of a name of the individual, a birth date of the individual, a birth place of the individual and a name of a parent of the individual.

27. A method according to claim 24, wherein the extended biometric identification number comprises biometric indicator data indicating a source of the biometric information provided from the individual.

28. A method according to claim 24, wherein the extended biometric identification number includes a signature for verifying an authenticity of at least a portion of the extended biometric identification number.

29. A method according to claim 28, wherein the signature includes time data for forming a time stamp.

30. A method according to claim 17, wherein the biometric identification number comprises fewer than 100 bytes.
